(19) United States
(12) Patent Application Publication
(10) Pub. No.: US 2009/0063302 A1
(43) Pub. Date: Mar. 5, 2009

(54) FLORIST BROKERAGE METHODS

(76) Inventor: Joshua Michael Greenwald, Waterford, CT (US)

Correspondence Address: STRATEGIC PATENTS P.C.., C/O PORTFOLIOIP, P.O. BOX 52050, MINNEAPOLIS, MN, 55402, US

(21) Appl. No.: 12/202,281

(22) Filed: Aug. 31, 2008

Related U.S. Application Data
(60) Provisional application No. 60/968,979, filed on Aug. 30, 2007.

(51) Int. Cl. G06Q 30/00; G06Q 50/00

(52) U.S. Cl. 705/27

(57) ABSTRACT

In embodiments of the present invention improved capabilities are described for florist methods. A method of providing a floral arrangement marketplace includes providing an implementation of a WYSIWYG interface that displays a floral arrangement; receiving a signal that indicates authorization to place a floral arrangement order for an actual floral arrangement, the actual floral arrangement substantially embodying the floral arrangement; creating the floral arrangement order; and transmitting the floral arrangement order to a floral arrangement provider.

### CROSS-REFERENCE TO RELATED APPLICATIONS

This application claims the benefit of the following provisional application:

U.S. Provisional Patent Application No. 60/968,979, entitled “Florist Brokerage System,” filed Aug. 30, 2007.

### BACKGROUND

As of August 2007, the retail fresh-cut flower industry in America was a $19 billion dollar per year industry. Approximately $6.6 billion of that is garnered by tens of thousands of small, local, usually family-owned, florist shops—each individually not typically bringing in more than $300,000 per year. Substantially all of these florist shops can create custom designed floral arrangements for various client needs.

Many florist shops have monopolies in local markets and amplify this local market penetration by accepting wire orders (by phone and/or internet) through brokers and clearinghouses, like Teleflora, FTD, 1800flowers.com, and others.

Brokers and clearinghouses sometimes take upwards of 30% of gross revenue per orders transacted and then often may take additional flat delivery fees, monthly subscription or network access fees, and so on. There is little ability for florist shops to exert leverage against the brokers and clearinghouses in order to reduce these fees. Moreover, consumers may not even realize that many florist shops have different costs and extend different prices. Thus, markets as presently implemented by brokers and clearinghouses are imperfect in that they tend to limit the power of both consumers and florist shops.

There exists a need for improved methods of providing a floral arrangement marketplace.

### SUMMARY

In one aspect, a method of providing a floral arrangement marketplace that is disclosed herein includes providing an implementation of a what-you-see-is-what-you-get (WYSIWYG) user interface that displays a floral arrangement, displays a set of floral arrangement elements, and allows a user to modify the arrangement; receiving a signal that indicates authorization to place a floral arrangement order for an actual floral arrangement, the actual floral arrangement substantially embodying the floral arrangement; creating the floral arrangement order; matching the floral arrangement order to a floral arrangement provider; and transmitting the floral arrangement order to the floral arrangement provider. The WYSIWYG user interface may further display a price for at least one of the floral arrangement and the floral arrangement element from the set of floral arrangement elements, the price determined at least in part according to a reverse auction. The WYSIWYG user interface may further display feedback for services rendered by floral arrangement providers. Matching the floral arrangement order to the floral arrangement provider may be performed at least in part according to a reverse auction. Matching the floral arrangement order to the floral arrangement provider may include receiving a signal that indicates said floral arrangement provider. The set of floral arrangement elements may include a floral arrangement element selected from the group consisting of a flower, baby's breath, a fern, decorative wood, a floral arrangement, a vase, a pot, a box, a container, a ribbon, cellophane, a card, a balloon, candies, and decorative plastic. The floral arrangement that may be displayed is rendered at least in part according to image deformation using moving least squares. Allowing the user to modify the arrangement may include allowing the user drag and drop a floral arrangement element from the set of floral arrangement elements into the floral arrangement. Allowing the user to modify the arrangement may include allowing the user to toggle a floral arrangement element's inclusion in the floral arrangement, the floral arrangement element being a member of the set of floral arrangement elements. The method of providing a floral arrangement marketplace may include receiving a commission based upon a reverse graduated scale.

In one aspect, a method of providing a floral arrangement marketplace that is disclosed herein includes providing an implementation of a WYSIWYG user interface that displays a floral arrangement, allows a user to specify a parameter associated with the floral arrangement, modifies the floral arrangement to embody the parameter as specified by the user, displays feedback for services rendered by floral arrangement providers, and displays a price for the floral arrangement; receiving a signal that indicates authorization to place a floral arrangement order for an actual floral arrangement, the actual floral arrangement substantially embodying the floral arrangement; creating the floral arrangement order; matching the floral arrangement order to one of the floral arrangement providers; and transmitting the floral arrangement order to said one of the floral arrangement providers. Matching the floral arrangement order to the floral arrangement provider may be performed at least in part according to a reverse auction. Matching the floral arrangement order to one of the floral arrangement providers may include receiving a signal that indicates said one of the floral arrangement providers. The set of floral arrangement elements may include a floral arrangement element selected from the group consisting of a flower, baby's breath, a fern, decorative wood, a floral arrangement, a vase, a pot, a box, a container, a ribbon, and cellophane. The parameter associated with the arrangement may be selected from the group consisting of price, color scheme, floral content guideline, price range, height, width, growing need, keyword, delivery detail, time limit, floral content, floral arrangement, cost, card, balloon, candy, payment detail, color, floral bloom detail, care need, feedback, availability, and past transaction. The floral arrangement that may be displayed is rendered at least in part according to image deformation using moving least squares. The method of providing a floral arrangement marketplace may include receiving a commission based upon a reverse graduated scale.

Throughout this disclosure, the words “provider,” “florist,” and “floral arrangement provider” may be used interchangeably, except where explicitly stated to the contrary or otherwise clear from the context.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a generalized software architecture for an online floral arrangement ordering and fulfillment system.

FIG. 2 depicts a method of providing a floral arrangement marketplace.

### DETAILED DESCRIPTION

A web-based floral arrangement ordering and fulfillment system is described herein. While the following architecture is specifically adapted to use in floral applications, it will be understood that the methods and systems described herein may be more generally applied to any market that requires matching of customized incoming orders with providers that have highly individualized offerings. These systems and methods may, for example, be usefully applied to other markets such as delivery of prepared foods or delivery of decorative table centerpieces. All such variations are intended to fall within the scope of this disclosure.

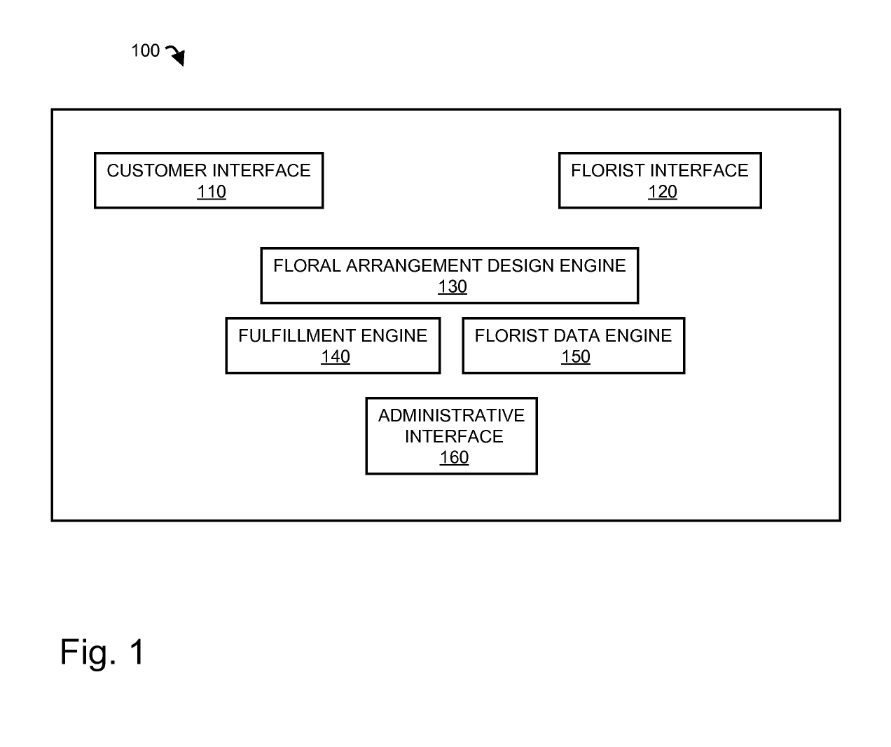

FIG. 1 shows a generalized software architecture for a floral arrangement ordering and fulfillment system. The system 100 may include a customer interface 110, a florist interface 120, a floral arrangement design engine 130, a fulfillment engine 140, a florist data engine 150 and an administrative interface 160. In general, the interfaces may be provided to users (e.g., florists and customers) using any suitable combination of web-based or other interface technologies.

The customer interface 110 may provide a user interface for receiving customer orders. A customer may specify parameters for an order, such as price, floral content, accessories (vase, balloons, personalized card, etc.), delivery address, payment details, delivery details, etc. The customer interface 110 may receive fixed parameters such as price, or a selection of specific flowers or a specific floral arrangement. A user may also, or instead, provide soft parameters such as a color scheme, floral content guidelines, price ranges, and so forth. The system 100 may receive the user-provided order details for processing through the fulfillment engine, described in greater detail below.

By way of specific functions that may be performed through the customer interface 110, a customer may enter and display personal details (e.g. but not limited to, name, age, gender, address, phone number, etc.) through a user interface to initiate a customer “account”, if desired. A customer may search (based on qualitative or quantitative criteria, such as but not limited to price, color, height, bloom size, care needs, allergens) via search tools for flowers and/or other products to include in floral arrangement. A customer may select flowers and/or other floral arrangement elements by graphically dragging and dropping from a catalog via a WYSIWYG modality into a “preview” of a floral arrangement (often displayed in a “preview” section of the customer front end). A customer may interact with floral arrangement design or employ design assistance applets to interact with floral arrangement design, and display floral arrangement design if possible. A customer may initiate email or otherwise sharing (with persons external to the system) selected floral arrangements and/or other products. The search tools, user interfaces, and the like may be implemented as web pages using HTML, CSS, PHP, Ajax, or Flash technologies, and the like. A variety of embodiments of search tools and user interfaces will be understood and all such embodiments are within the scope of the present disclosure.

A customer user interface 110 may display selected floral arrangement and/or other product prices and their possible providers' reputations for comparison; optionally automatically request purchase from lowest-bidding provider(s) of a selected floral arrangement and/or other product. In some embodiments, the prices may be determined at least in part according to a reverse auction in which the possible providers give quotations or place bids, which can be compared against one another. It will be understood that such bidding may be based upon triggers, limits, or other preset values.

A customer may input selected floral arrangements and/or other products in a virtual shopping cart. A customer may initiate a purchase by inputting, verifying, or otherwise providing payment or payment information for selected floral arrangement and/or other product. It will be understood that a variety of forms of payment and payment information are possible.

A customer may display status of shipment of purchase. A customer may input, initiate, receive, and display communication with technical and customer support services. A customer may input and display feedback for services rendered. A customer may display customer account history: purchases, feedback, support communications, etc.

In order to participate in the system 100, individual florists may use the florist interface 120. This interface may provide a number of florist functions. In one aspect, a florist may directly interact with the system 100 to monitor incoming customer orders and manually respond to individual orders, such as by providing a price-based offer or by accepting a customer order as is (depending in part upon the manner in which the fulfillment engine 140 performs matching of orders to florists). In another aspect, a florist may provide data to the florist data engine 150, such as delivery range and capacity, floral stock, prices, accessories, specials, pre-made floral arrangements, and so forth. This data may be employed to automatically make offers or accept orders on behalf of the florist within the system 100. In this embodiment, orders are then automatically forwarded to florists for fulfillment.

The florist interface may allow participating floral firms to track sales and feedback and to detail their wholesale or retail line item/service prices for use in automatically calculating and presenting offers. By way of specific functions that may be performed through the florist interface 120, a florist may enter and display data about a provider firm, e.g. name, contact information, billing information, flower prices, flower availabilities, other product(s) price(s) and availabilities, past transactions, reputation/feedback history, etc. A florist may display public general information about oneself, such as by example a one-page profile page with a certain set of contact and other details. A florist may input and display communication, such as by example with system administrators, customers, public visitors. A florist may input, initiate, send, receive, and/or display payments, e.g. by credit card, bank transfer, etc., for services and/or products rendered. A florist may analyze and display data of current or past transactions for which provider is/was responsible, including data such as by example floral arrangement/flower criteria, design order, customer name, delivery address, status, etc.

The floral arrangement design engine 130 may provide user assistance in designing or selecting a floral arrangement. This may include any number of suitable selection techniques. For example, the floral arrangement design engine 130 may, through the customer interface 110, lead a user through a series of questions that lead to a selection of one of a fixed number of floral arrangements. The engine 130 may also, or instead, present a number of available specials, or may present visually depictions of floral arrangements or their possible constituent floral parts for direct point-and-click selection, combination, or manipulation. These presentations may be arranged hierarchically to display in various areas of a page or pages, e.g., by color, sizes, average prices, seasonal arrangements, special occasion arrangements, and/or so forth. In another aspect, the engine 130 may provide assistance such as artificial intelligence, expert systems, and the like to assist a user in designing a customized floral arrangement based upon style or design preferences, color preferences, floral preferences or other parameters. The engine 130 may further render a depiction of a customized display using related artwork for each floral arrangement component.

The floral arrangement design engine may also include related AI and database programming and/or may include an applet for suggesting alternatively permuted possible floral arrangement designs, whatever the amount the user does or does not wish to design oneself. For example, if the user only wishes to input a few parameters and let the system do the rest, the user can do so. For example, if the user wishes to input many parameters but still receive other possible design permutations, the user can also do so. Such programming may also include an applet—usable either with self-designed or assisted orders—to track the pricing of floral arrangements and predict the probability of filling orders at given prices and other parameters based on the history of comparable orders.

However, designed or selected, a floral arrangement order may then be submitted to the fulfillment engine 140, which matches incoming customer orders with participating florists. The system may be fully automated so that a user merely places an order and has the order fulfilled. In one aspect, the system 100 may automatically select a florist using a Dutch auction, low-bidder based auction engine such as and without limitation a reverse auction, or the like. In another aspect, the system 100 may employ some degree of partial automation so that incoming orders are matched with a number of different florists based upon, e.g., the florist's indication of availability, a florist's description of available flowers and arrangements, a florist's geographical delivery area, and so forth.

An administrative interface 160 may be provided for administrative access to the system 100. The administrative interface may provide executive oversight command and control for the site. By way of example and not of limitation, an administrator may use the administrative interface 160 to analyze data about all types of users of the system, including whether they are logged in/online, their current activity and page view, their typical usage patterns, geographic information, ip information, etc. The administrative interface 160 may be used to analyze data about the system's information flow and load overall. The administrative interface 160 may display and modify permissions and accesses of various users at any given time.

In addition to the specific components described above, the system 100 may provide back end processing which may be incorporated into one or more of the floral arrangement design engine 130, the fulfillment engine 140, and the florist data engine 150, and may also, or instead, include other processes to support back end processing associated with the systems and methods described herein. Back end processing may, for example, store, sort, and otherwise manipulate customer details, including for examples purchase and feedback histories, contact information, payment information, and others, in MySQL or other database formats, often for its query and display in various interface web pages. Back end processing may store, sort, and otherwise manipulate flower, floral arrangement, and other product data in MySQL or other format database, often for its query and display in interface web pages. Back end processing may store, sort, and otherwise manipulate provider details, including for examples purchase and feedback histories, contact information, payment information, and others, in MySQL or other format database, often for its query and display in interface web pages. Back end processing may store, sort, and otherwise manipulate floral arrangement design templates, often stored in a novel bit array or other encoding format; at option of customer, may apply any one or more said templates (one at a time) to prospective floral arrangement orders to present (often in “preview” sections of the various interfaces) possible floral arrangement styles the customer might wish to order from a provider. Back end processing may calculate probabilities of fulfilling prospective customer orders of flowers, floral arrangements, and/or other products, based on historical data of similar orders, and may make suggestions for optimal fulfillments. Back end processing may provide algorithms to aggregate and/or calculate price(s) of selected floral arrangement (or its equivalent criteria) and/or other products. Back end processing may provide algorithms to aggregate feedback and other criteria of reputation as inputted by customers over time. Back end processing may verify financial credibility of buyer and provider; transfer funds to and from banking and credit institutions as necessary for credits and payments. Back end processing may transfer, store, and otherwise coordinate communications between various parties. Back end processing may store, sort, coordinates, and otherwise manipulate data regarding shipments of orders.

Numerous additional aspects of the system and various embodiments thereof are now described in greater detail.

Three user interfaces may be provided for a user (e.g., consumer), provider (e.g., florist), and administrator. Each user interface may employ a combination of Flash, Ajax, PHP, CSS, XHTML, or the like in a front end to allow users to design their own floral arrangements and where appropriate, to revise these designs according to florist constraints such as flower selection, vase selection, and so forth. The interfaces may provide artists' digital graphic reproductions of individual flowers offered in floral arrangements to provide a simulated view of a user-created design. It will be understood that the interfaces may alternatively be implemented as widgets, applications, executables, or the like.

In one aspect, the system 100 may create a network among participating floral firms, such as local shops, supermarkets, or other professional floral providers who register with the system. The system may be open to any firm that provides certain subscription data, which may include, for example, a verifiable government id/company tax information, electronically accessible business bank account or credit account information, and/or explicit agreement to terms of service. Through the florist interface 120, each participating firm may post their wholesale or retail line item/service prices for use by internal algorithms in presenting consumers fulfillment offers.

In another aspect, an operator of the system 100 may partner with artists to provide aforementioned product graphics and/or manufacturers to provide licensed accessories, such as vases and other containers and accessories, which participating firms may order to offer consumers.

In some embodiments, a user may be able to design, more or less exactly, the floral arrangement he wants. Some embodiments may provide a floral arrangement at a substantially optimal or low price by enabling floral arrangement providers to bid against one another in a reverse auction. Some embodiments may provide access to a more or less complete national network of florists, allowing a user to select floral arrangements from any and all florists in the network. Some embodiments may provide detailed feedback mechanisms directed at keeping providers honest, avoiding consumer dissatisfaction, and maintaining highest levels of quality.

Some embodiments may provide a centralized entity and method for advertising, finding, tracking, and filling new consumers/orders. Some embodiments may provide a way for a local florist to advertise and avail itself to a relatively broad market (as opposed to being an anonymous backend or subcontractor to an intermediary).

The system 100 may be supported by conventional marketing techniques including, for example, e-mail campaigns and promotions, which may be targeted in part using a customer's personal account section of the website. Florist relationships may be maintained in a similar manner. Telephone customer support may also be provided as needed.

Revenue may be realized using a number of models. For example, the system 100 provider may receive a commission on each transaction, either based upon gross transaction size, net transaction value, or some other metric. This may include variable commissions according to, e.g., order size, order volume (as measured daily, weekly, monthly, annually, or over some other time period), and so forth. Commissions may also be adjusted according to other metrics such as customer feedback, success in competitive bidding, and the like. In addition, the commission may be adjusted, or surcharges may be assessed for use of value-added services such as the floral arrangement design engine. In another aspect, participating florists may be charged a subscription, which may be accompanied by a guarantee of a certain sales volume, or a certain percentage of available sales volume, or some combination of these.

In some embodiments, the commission may be calculated according to a reverse graduated scale. It will be understood that a variety of other approaches to calculating the commission are possible.

For example and without limitation, a reverse-graduated scale may be used for calculating commissions wherein each floral arrangement provider, depending on its sales to date for the month, may fall into one of several categories: For a provider that has produced $10,000 or less sales that month the commission on sales may be 29.99%. For a provider producing $10,000-$20,000 in sales that month the commission may be 25.99%. Similarly, for a provider producing $20,000-$30,000 in sales the commission may be 23.99%, and so on.

In some embodiments the commission may reflect each floral arrangement provider's cumulative feedback rating. For example and without limitation, those floral arrangement providers with better feedback may be rewarded: Feedback of 51-60% good may result in a 1% reduction of the commission; feedback of 61-70% good may result in a 1.5% reduction of the commission; and so on. Conversely, those floral arrangement providers with worse feedback may be penalized: Feedback of 41-50% good may result in a 1% increase of the commission; feedback of 31-40% good may result in a 1.5% increase of the commission; and so on.

The foregoing may be further understood with reference to the following situations, which are provided for the purpose of illustration and not limitation. In situation 1, there is floral arrangement provider ‘A’ that currently has produced $29,000 in gross sales in a month with a cumulative feedback rating of 65% good. In situation 2, there is a floral arrangement provider ‘B’ that currently has produced $51,000 in gross sales that month with a cumulative feedback rating of 49%. A consumer places a $50 order through each provider. Provider ‘A’ may receive a net distribution of sales revenue of approximately $38.75 (=$50−($50*(23.99%−1.5%))), with the residual $11.25 (=$50−$38.75) left for the operator of the system 100. Provider ‘B’ may receive a net distribution of sales revenue of approximately $40.50 (=$50−($50*(17.99%+1.0%))), with the residual $9.50 (=$50−$40.50) left for the operator of the system 100.

In another aspect, advertising space may be sold and displayed on the customer interface 110, the florist interface 120, and so on. In some embodiments, the advertising space may be sold via an advertising network such as and without limitation Google AdSense, other Internet advertising services, or the like.

The user interface may include the user's web page-enabled ability to self-design and then purchase one's own floral arrangements. The interactive self-designing ability, which may be powered by the floral arrangement design engine 130, may without limitation include (1) a repository of commonly available flowers all realistically illustrated (e.g., individual flowers, complete with bud and stem) and other floral arrangement products, such as baby's breath, ferns, decorative wood, et cetera; (2) a repository of commonly available and also proprietarily available container products, such as vases, pots, ribbons, cellophane, boxes, et cetera; (3) a web page-enabled ability to select a desired container from (2) and then to drag desired flowers, one by one (or whatever appropriate quantity), from (1) into the selected container, thereby building one's own floral arrangement exactly to one's own liking; and (4) an ability to engage the floral arrangement design engine 130 for alternative design permutations possible given selected parameters. Therein the user oneself is able to build a floral arrangement with a personal touch and flavor exactly as might be done at any local florist shop, but without actually having to go there.

If one wishes merely to specify the kinds of flowers or colors or other characteristics about one's floral arrangement, but does not actually wish to further select or design the arrangement, one may instead request and select such parameters within the user interface. The user may then request the fulfilling florist shop undertake the artistic design and executive decisions—or the user may select to have the system 100 design-assistance logic, such as the floral arrangement design engine 130, suggest an alternative arrangement order with the parameters. In general, this assisted design procedure may be intended to recreate as closely as possible the experience of visiting a local florist shop and engaging the artistry of a florist.

In some embodiments, business logic may let local markets (as opposed to, for example, national trends) determine prices according to local supply and demand. As well, when local florist providers win and fulfill orders, they may add to a historical transaction archive. This data (by predicting fulfillment probabilities and other internal statistical modeling) may help consumers ensure optimal fulfillment of orders and benefit from a transparently and precisely articulated market.

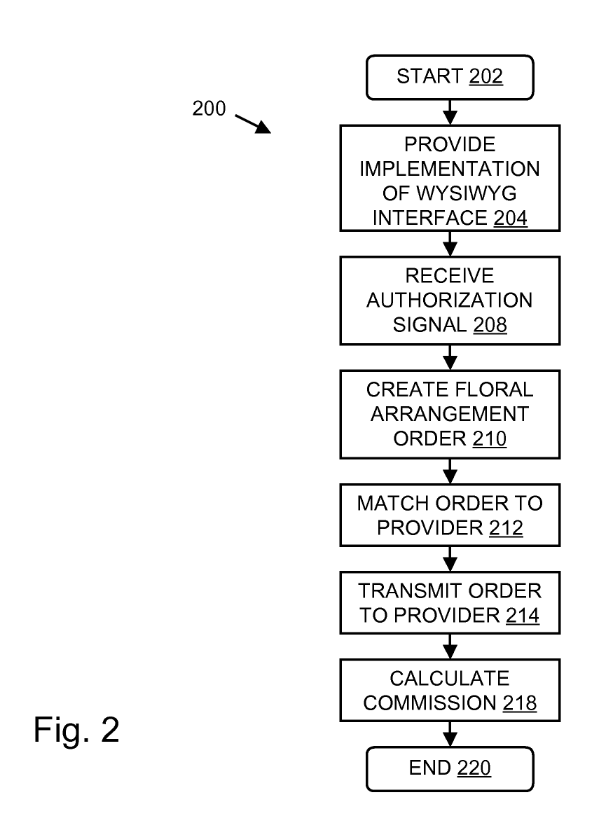

FIG. 2 depicts a method of providing a floral arrangement marketplace. Beginning at block 202, the method 200 may provide an implementation of a WYSIWYG user interface as shown in block 204. The WYSIWYG interface may display a floral arrangement, display a set of floral arrangement elements, allow a user to modify the arrangement, and so on.

In some embodiments allowing the user to modify the arrangement may include allowing the user to drag and drop floral arrangement elements into, out of, and within the floral arrangement. In some embodiments allowing the user to modify the arrangement may include providing radio buttons, check boxes, or the like that allow the user to toggle a floral arrangement element's inclusion in the floral arrangement. A variety of ways of allowing the user to modify the arrangement within the WYSIWYG interface will be understood.

Alternatively or additionally, in some embodiments the WYSIWYG user interface may first allow a user to specify a parameter associated with the floral arrangement and then modify the floral arrangement to embody the parameter as specified by the user. The parameter associated may indicate price, color scheme, floral content guideline, price range, height, width, growing need, keyword, delivery detail, time limit, floral content, floral arrangement, cost, card, balloon, candy, payment detail, color, floral bloom detail, care need, feedback, availability, and past transaction.

It will be understood that a variety of parameters are possible, and that a variety of modifications to the floral arrangement correspond to such parameters. For example and without limitation, the user may specify a parameter that indicates the color blue. In response to this, the WYSIWYG user interface may modify the floral arrangement so that it is substantially blue. For another example and also without limitation, the user may specify a parameter that indicates a price range. In response to this, the WYSIWYG user interface may modify the floral arrangement so that its price is within the price range. Numerous other examples will be appreciated, and all such examples are within the scope of the present disclosure. Furthermore, it should be appreciated that a plurality of parameters may be specified and that the WYSIWYG user interface may modify the floral arrangement in response to some or all of the plurality of parameters.

In some embodiments the WYSIWYG interface may display a price for the floral arrangement. In some embodiments the WYSIWYG interface may display a floral arrangement element from the set of floral arrangement elements.

In some embodiments prices may be determined in accordance with a reverse auction or the like. For example and without limitation, a server may conduct a reverse auction to determine a price and then transmit the price to an instantiation of the WYSIWYG user interface. For another example and also without limitation, the implementation may include a computer program that conducts, at least in part, the reverse auction. Still other such examples will be appreciated.

In some embodiments the WYSIWYG interface may display feedback for services rendered by floral providers. For example and without limitation, feedback from one or more sources may be transmitted to an instantiation of the WYSIWYG user interface, which then displays the feedback. For another example and also without limitation, the WYSIWYG user interface or another application may store feedback on a computer, disk, memory, or the like that is local to an instantiation of the WYSIWYG user interface. In this example, the WYSIWYG user interface may access the local feedback and then display the feedback. Other such examples will be appreciated.

In some embodiments, providing the implementation may include transmitting a web page, Flash application, Java applet, or the like. It will be understood that a variety of systems and methods that transmit this interface are possible.

The method 200 may receive a signal that indicates authorization to place a floral arrangement order for an actual floral arrangement as shown by block 208. The actual floral arrangement may substantially embody the floral arrangement that the WYSIWYG interface displays. In some embodiments, receiving the signal may include receiving an IP data packet, SMS or MMS message, or the like. It will be understood that a variety of systems and methods that receive the signal are possible.

The method 200 may create a floral arrangement order as shown by block 210. In some embodiments, the floral arrangement order may be for the actual floral arrangement. In some embodiments, the floral arrangement order may include a digital record (e.g. an email, an electronic fax document, a recorded audio message, a database record, a data file, and so on); a paper record; or the like. It will be understood that a variety of embodiments of the floral arrangement order are possible.

The method 200 may match the floral arrangement order to a floral arrangement provider (e.g. a florist, florist shop, or the like) as shown by block 212. The matching, which is described in greater detail herein above and elsewhere, may be performed at least in part according to a reverse auction or may comprise receiving a signal that identifies said floral arrangement provider. In some embodiments receiving the signal may include receiving data via the Internet, a digital communications network, or the like. It will be understood that a variety of systems and methods that perform the matching are possible.

Transmitting the floral arrangement order to the floral arrangement provider may occur (as shown by block 214) before the method 200 ends at block 220. In some embodiments, transmitting the floral arrangement order may include transmitting an IP packet, transmitting a fax, placing a phone call, or the like. It will be understood that a variety of systems and methods that transmit the floral arrangement order are possible.

In some embodiments, the method 200 may include calculating a commission for matching the floral arrangement order to a floral arrangement provider based upon a reverse graduated scale, as described herein and elsewhere, and as shown by block 118. It will be understood that a variety of computing systems for calculating the commission are possible.

In some embodiments the WYSIWYG user interface may include the customer interface 110. In some embodiments the WYSIWYG interface may display a floral arrangement. It will be understood that a variety of algorithms or heuristics for generating the floral arrangement are possible. For example and without limitation, such an algorithm may be based at least in part upon “Image Deformation Using Moving Least Squares,” by Schaefer, et al, ACM Trans. Graph 25 (3), 553-540 (2006). This algorithm may proceed as follows:

1. A series of pivot points must be selected on each image. These pivots are initial points for the moving least squares (MLS) algorithm that determine how that image will be deformed. In theory, a sparse selection of points will not produce as strong results as a dense selection of points on the salient features of the image. This step may be performed manually by a user or may be substantially automated using computer vision-based techniques. A variety of such techniques will be appreciated.

2. Two vectors must also be chosen for each image before the engine can be deployed. These vectors are selected for the top and bottom portion of each image. They are then normalized and interpolated vertically across the initial point positions. The interpolation produces a vector for each initial point position that determines how the initial points will be moved into their corresponding final positions. The vectors may be selected manually or may be selected substantially automatically using computer vision-based techniques. Final points with corresponding initial points closer to the bottom of the image will be more strongly influenced by the bottom vector and vice versa. Conceptually, these vectors are related to the rigidity of the flower component represented in each image. For example, vectors with a slope of less than one relate to a flower component that is not bent as strongly when influenced by external forces.

3. Once the two previous conditions are satisfied, the rendering engine may be deployed. When the rendering engine receives a request to produce a stylized floral arrangement, it reads the appropriate images and associated data produced from the previous two steps. In the third step, the rendering engine calculates a position for each flower in the floral arrangement and uses this information to determine the corresponding direction and bend factor to apply to a given flower. The bend factor is used to determine the final position points for each initial pivot chosen in step 1. The bend factor is calculated using a function based on an exponential, in particular: y=(êx)̂a where x and y are vectors whose entries correspond to the pivot points in an image and a corresponds to external force exerted on the flower component, such that a smaller a will result in a bigger bend in the image. The resulting values stored in y determine how far each initial point position is moved along its interpolated vector computed in 2.

4. Once the final position points are chosen, the image and its corresponding initial and final pivot points are fed into the deformation engine based on [1], and the output is composited into the final stylized floral arrangement image.

5. Steps 3 and 4 are repeated for each flower in the floral arrangement. When all the flowers have been processed and composited, any additional decorations are added, and the final result is outputted to an image file for further display and use by the system 100 or related methods.

It will be appreciated that the methods and systems above may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, Internet or World-Wide-Web-specific programming languages, and database programming languages and technologies) that may be stored, compiled or interpreted to run on one of the above devices, as well as heterogeneous combinations of processors, processor architectures, or combinations of different hardware and software. At the same time, processing may be distributed across a number of computing devices in a number of ways, or all of the functionality may be integrated into a dedicated, standalone client and/or server device or other hardware. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method of providing a floral arrangement marketplace, the method comprising:
providing an implementation of a what-you-see-is-what-you-get user interface that displays a floral arrangement, displays a set of floral arrangement elements, and allows a user to modify the arrangement;
receiving a signal that indicates authorization to place a floral arrangement order for an actual floral arrangement, the actual floral arrangement substantially embodying the floral arrangement;
creating the floral arrangement order;
matching the floral arrangement order to a floral arrangement provider; and
transmitting the floral arrangement order to the floral arrangement provider.

2. The method of claim 1 wherein the what-you-see-is-what-you-get user interface further displays a price for at least one of the floral arrangement and a floral arrangement element from the set of floral arrangement elements, the price determined at least in part according to a reverse auction.

3. The method of claim 1 wherein the what-you-see-is-what-you-get user interface further displays feedback for services rendered by floral arrangement providers.

4. The method of claim 1 wherein matching the floral arrangement order to the floral arrangement provider is performed at least in part according to a reverse auction.

5. The method of claim 1 wherein matching the floral arrangement order to the floral arrangement provider comprises receiving a signal that identifies the floral arrangement provider.

6. The method of claim 1 wherein the set of floral arrangement elements comprises a floral arrangement element selected from the group consisting of a flower, baby's breath, a fern, decorative wood, a floral arrangement, a vase, a pot, a box, a container, a ribbon, cellophane, a card, a balloon, candies, and decorative plastic.

7. The method of claim 1 wherein the floral arrangement that is displayed is rendered at least in part according to image deformation using moving least squares.

8. The method of claim 1 wherein allowing the user to modify the arrangement comprises allowing the user drag and drop a floral arrangement element from the set of floral arrangement elements into the floral arrangement.

9. The method of claim 1 wherein allowing the user to modify the arrangement comprises allowing the user to toggle a floral arrangement element's inclusion in the floral arrangement, the floral arrangement element being a member of the set of floral arrangement elements.

10. The method of claim 1 further comprising calculating a commission for matching the floral arrangement order to a floral arrangement provider based upon a reverse graduated scale.

11. A method of providing a floral arrangement marketplace, the method comprising:
providing an implementation of a WYSIWYG user interface that displays a floral arrangement, allows a user to specify a parameter associated with the floral arrangement, modifies the floral arrangement to embody the parameter as specified by the user, displays feedback for services rendered by floral arrangement providers, and displays a price for the floral arrangement;
receiving a signal that indicates authorization to place a floral arrangement order for an actual floral arrangement, the actual floral arrangement substantially embodying the floral arrangement;
creating the floral arrangement order;
matching the floral arrangement order to one of the floral arrangement providers; and
transmitting the floral arrangement order to said one of the floral arrangement providers.

12. The method of claim 11 wherein matching the floral arrangement order to the floral arrangement provider is performed at least in part according to a reverse auction.

13. The method of claim 11 wherein matching the floral arrangement order to one of the floral arrangement providers comprises receiving a signal that identifies said one of the floral arrangement providers.

14. The method of claim 11 wherein the set of floral arrangement elements comprises a floral arrangement element selected from the group consisting of a flower, baby's breath, a fern, decorative wood, a floral arrangement, a vase, a pot, a box, a container, a ribbon, and cellophane.

15. The method of claim 11 wherein the parameter associated with the arrangement is selected from the group consisting of price, color scheme, floral content guideline, price range, height, width, growing need, keyword, delivery detail, time limit, floral content, floral arrangement, cost, card, balloon, candy, payment detail, color, floral bloom detail, care need, feedback, availability, and past transaction.

16. The method of claim 11 wherein the floral arrangement that is displayed is rendered at least in part according to image deformation using moving least squares.

17. The method of claim 11 further comprising calculating a commission for matching the floral arrangement order to one of the floral arrangement providers based upon a reverse graduated scale.
